(19) United States
(12) Patent Application Publication
(10) Pub. No.: US 2009/0191514 A1
(43) Pub. Date: Jul. 30, 2009

(54) Calorie Counter

(76) Inventor: Judy Barnow, Northridge, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/020,430

(22) Filed: Jan. 25, 2008

(51) Int. Cl. G09B 19/00

(52) U.S. Cl. 434/127

(57) ABSTRACT

A calorie counter that uses a voice command function to transition between various functional modes while maintaining the portability and aesthetic value as an accessory. Preprogrammed memory contained within the system pertains to reported nutritional information relating to specific food/beverage items and also dishes served at restaurants. This information may be ordered via voice command by the consumer, who then receives the information on a display screen and/or conventional synthesized voice and speaker function, before opting to record the number of calories or other nutritional item that was ingested. This recorded information is transferred to an electronic log where it can be reviewed at any time.

### FIELD OF THE INVENTION

The present invention relates to a portable electronic system comprising conventional voice command technology, a display screen and data memory function in order to both report and log such information as the amount of calories contained in a specific food item as requested by the user.

### BACKGROUND OF THE INVENTION

Health concerns are one of the primary issues facing people of all ages. And one of the most important health issues relates to obesity. Obesity is known to play a significant role in child physical and mental development. Obesity and overweight issues also plays a direct role in other health problems such as heart disease, high blood pressure and diabetes. In fact, overweight issues and obesity cause additional hazards to society than merely individual health problems. This includes increased health coverage and sometimes-lower productivity due to increased health issues. One particular international study by the Organization for Economic Cooperation and Development (OECD) reported in 2007 that the top five obesity rates in the world were the United States (32.2%), Mexico (30.2%), United Kingdom (23%), Greece (21.9%) and Australia (21.7%). That particular study correlated obesity rates with increased healthcare spending.

While obesity rates remain high, there are no shortages of diet programs available for consumers. While it is generally accepted that exercise and proper diet are the keys to good health, it is often incumbent on the individual consumer to monitor his or her food intake. This is one reason why many jurisdictions require nutritional information to be labeled on food and beverage containers. Many consumers use this information to determine whether or not they wish to purchase certain items.

Moreover, one very common food and beverage intake monitoring technique is to maintain an ongoing log relating to such items as calorie intake. This technique is integrated into many diet programs such as WEIGHT WATCHERS™ where a point system and notebook is used so that consumers can remain with specified food intake limits. Other calorie-conscious techniques utilize similar methods in terms of ongoing logs.

These logs range from typical pencil and paper recordings to the use of computer software. However, a significant problem with these techniques is that it takes a bit of work on the part of the consumer to consistently maintain these records. All too often, consumers give up maintaining logs. Diets are not easy and all it may take is for a consumer to forget his or her log notebook, or find that the pen ran out of ink, for the process to be interrupted and ultimately abandoned.

Another problem with typical calorie-counting techniques revolve around time. It takes time for consumers to read through food labels. It also takes time to determine food-proportion sizes. And the issue of time and convenience comes into play for consumers who eat food from restaurants. For example, a consumer typically must log onto a restaurant Web site or specifically ask a restaurant employee in order to view nutritional information. While nutrition information may be posted at certain fast-food outlets, it is not so prevalent in the drive-thru. The same issue affects slightly more formal restaurants. To that end, there is a need for a device that can maintain a stored database containing thousands of food items. This need includes the requirements that the device must be portable, easy to use, and contain the ability to not only report nutritional information of food items and restaurant options, but also make a log of nutritional items consumed by the user.

The present invention is a novel system that satisfies these needs while taking into account the aforementioned common pitfalls that consistently trap health-conscious consumers. Instead of pens and pencils coupled with a notebook—all of which can get buried in a purse or lost in a pile—the present invention serves as a unique and handy solution. The present invention can be treated as an accessory similar to a watch, music player or even a pedometer. When the consumer encounters a food item, he or she merely utilizes the voice-command function of the present invention by verbally stating the name of the food item. The present invention will quickly search through its database to provide the consumer with the requisite information. The consumer may then verbally or manually instruct the present invention to record such nutritional information as calories for the consumed food item into the log of the present invention. Proportions and time of day regarding the food consumption are all taken into account in a quick and easy manner. For these reasons, the present invention solves these ongoing problems relating to food-intake monitoring.

U.S. Pat. No. 4,159,416 issued to Brejnik et al on Jun. 26, 1979, is an electronic calorie counter that is portable in the same manner as a wristwatch. Unlike the present invention, Brejnik counts calories that are burned, as well as heart rate, through calculated metabolic rates based on pulse. The present invention, in contrast, assists consumers as they seek to monitor the amount of calories and other nutritional information that they ingest.

US application 2004/0225533 filed by Cosentino et al is a weight management system that includes alerts for when a user exceeds an allotted amount of daily calories. Unlike the present invention, Cosentino and its subsequent computing system fails to solve the fundamental problems of nutritional management because consumers using Cosentino still must work to input information and to seek answers to more detailed questions. The present invention, meanwhile, uses a voice command secured to a portable system that works to make the process of seeking and logging nutritional information seamless. Moreover, the present invention is streamlined for more independent use through the use of simple memory storage elements that contain information relating to nutritional values of food items on the market and in various restaurants. This information of the present invention that is presented through the memory storage element can then be logged if the user decides to ingest that particular food or beverage item.

Based on existing calorie counting devices, there remains a need for a system that streamlines a consumer's ability to exert very little effort to continuously log, monitor and research nutritional information. The fact exists that most health conscious consumers will be inconsistent in this very important task, which as mentioned above, leads to indifference, quitting and sometimes “yo-yo” weight control. The present invention satisfies this need through its unique memory storage element working in conjunction with the voice command function of the system. The present invention also makes it simpler for consumers of all physical abilities to monitor their nutritional information through the conventional synthesized voice and speaker function. This function conveys the information to the consumer verbally so he or she is not relying solely on the textual information of the display screen. Because of these unique qualities embedded in the system, the present invention provides a seamless and hands-free avenue for consumers to monitor and log their nutritional intake.

### SUMMARY OF THE PRESENT INVENTION

The present invention is a portable electronic system that is used to dispense stored nutritional information while also serving as a logging device for nutritional intake. An example included in the preferred embodiment of the present invention envisions the system to be used by consumers as a calorie counter. In this capacity, a consumer will verbally state the name of the food item that had been or is about to be consumed. The present invention will then display the number of calories relating to the specific food item. In addition, the present invention also has the capability to verbally convey this information to the consumer. The consumer may then either verbally or manually instruct the present invention to record the number of calories for that food item and place the information into a log. The present invention then may record the time and date of the calorie intake. The present invention also adds the total calorie count for the specified time and date for viewing by the consumer.

The preferred embodiment of the present invention relates to a portable electronic system that can be treated in similar manner as other personal accessories. Since the present invention may display time and date, the system can double as a wristwatch. Other examples include doubling as a heart monitor, pedometer, portable music player, computer memory stick, belt buckle and keychain. The present invention can be ingratiated into virtually any type of personal item.

A primary element of the present invention includes a voice command function. The voice command function relates to conventional technology familiar with those skilled in the field. Sound receiving pieces used to recognize specific voice commands are located at various points of the system housing. The preferred embodiment places these sound receiving pieces on the left and right side of the present invention in order to effectively capture relevant voice commands. When a voice command or specific food or beverage item is spoken and the voice reaches the sound receiving pieces, the present invention recognizes the word. Through pre-programmed or downloadable algorithms, these commands are interpreted by the system of the present invention through the memory storage element located inside present invention housing. An additional embodiment of the present invention envisions a receiver/transmitter device attached to the system so that commands can be sent via wireless communications technology to a distant database that essentially retrieves the coded signal based on the initial voice command and returns the requested data through the distant database transmitter and back to the receiver/transmitter device of the present invention.

It is important to note that a consumer does not have to log and record the information that is verbally requested and ultimately is seen on the display screen. For example, a consumer may simply issue the verbal command for the name of a WHOPPER™ sandwich. The system of the present invention will seek the nutritional information for that product from within the memory storage element. This nutritional information will then be visible on the display screen and/or verbally convey the nutritional information via conventional synthesized voice and speaker function. At this point, the consumer can use that nutritional information merely to receive the information relating to that sandwich. In other words, the consumer may simply view the nutritional information and ignore it, verbally command the system to a different mode or move on to a different food or drink item. However, the consumer also may log and record the nutritional information for that sandwich. One embodiment of the present invention envisions a “yes” or “no” command where once the nutritional information of a product is displayed, the system will ask the consumer if he or she would like to log that item. Another embodiment envisions that the consumer may simply command that the system “log WHOPPER™.” Variations on that aspect include proportions and product variations such as a sandwich with cheese or condiments.

In the preferred embodiment of the present invention, the system possesses the option for a standard, voice-activated password that is stored within the voice command mainframe. This voice-activated password would be used by the consumer to verbally activate and deactivate the system for use. The preferred embodiment also enables uniquely crafted password creation by the consumer through the standard voice command pre-programmed operation.

Along with the housing of the present invention, the most prominent item to be seen by the consumer is the display screen. The display screen uses a liquid-crystal display in the preferred embodiment but also may employ virtually any other type of conventional display screen conducive to portable technology. The display screen is where the information stored within the system will be displayed for the consumer. Speakers also may emanate from the display screen for the conventional synthesized voice and speaker function.

In the preferred embodiment, the memory database is stored within the system and may be preprogrammed with information relating to nutritional items for numerous food and restaurant items. An additional embodiment of the present invention envisions an update function through a receiver/transmitter to a stationary database or a USB port located within the system of the present invention for direct downloads at the consumer's convenience.

A conventional time-keeping mechanism works with the memory storage element of the present invention in order to maintain logs and perform such simple mathematics as counting calories consumed over the course of a set period of time. The preferred embodiment relates to a rechargeable battery. A conventional power source such as a small lithium battery also may be used to maintain the steady power necessary to operate the present invention.

### BRIEF DESCRIPTION OF THE DRAWINGS

FIG. 1 is a view of the present invention in silent mode.

FIG. 2 is a view of both sides of a preferred embodiment of the present invention.

FIG. 3 is a view of the present invention while displaying nutritional information.

FIG. 4 is a view of the present invention displaying total calories logged.

FIG. 5 is a view of the present invention in restaurant mode.

FIG. 6 is a view of the present invention in an alarm mode.

FIG. 7 is a view of the present invention in a pedometer mode.

FIG. 8 is a flow chart detailing how the system of the present invention may flow through use in the preferred embodiment.

### DETAILED DESCRIPTION OF THE PREFERRED EMBODIMENT

The present invention is capable of entering into a number of different modes. These modes serve the system of the preferred embodiment to maintain the portable, informational and log recording capability of the present invention. The database, herein also sometimes referred to as a memory storage capability, has various modes as further described below. The following figures depict embodiments of the present invention for various conceived manifestations of the present invention, although countless other dual-use aspects are considered.

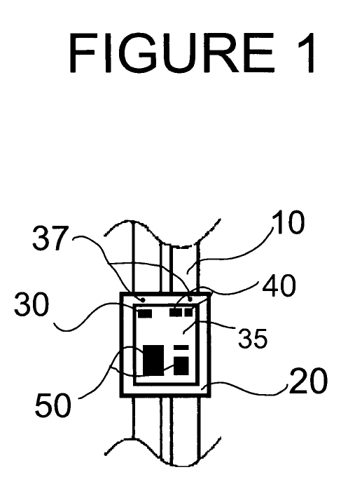

The primary aspects of the preferred embodiment relate to portability, memory storage, display of information, conventional synthesized voice and speaker function, logging ability and ease of use. In FIG. 1, we see a view of the preferred embodiment of the present invention while in a silent mode. The silent mode as seen in FIG. 1 highlights the ease of use aspect of the present invention. In this embodiment, we see a wrist connector (10) that is secured to the housing (20) of the present invention via conventional means. The wrist connector (10) effectively creates a system where the present invention is doubled as a wristwatch as the wrist connector (10) is essentially a watchband. In fact, silent mode as seen in FIG. 1 is little different than a traditional watch in that we see the day (30), date (40) and time (50) is located on the display screen (35). In an additional embodiment of the present invention, the silent mode information such as time (50), date (40) and day (30) can be viewed on the display screen (35) while the system is in all other modes. This occurs when the consumer merely issues a verbal command via the voice command function of the present invention. By doubling the present invention as a watch, the consumer does not have to pay much special attention to the present invention as it becomes part of the consumer's accessories in a potentially aesthetically pleasing manner. The wrist connector (10) also is one embodiment that will literally keep the present invention at hand rather than buried in a purse or prone to loss. Other embodiments also are considered, such as necklace connections, clips, mobile phones and PDAs.

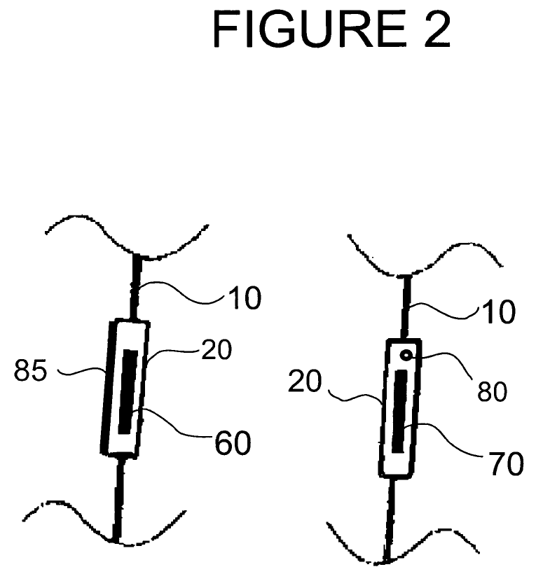

The purpose of silent mode as seen in FIG. 1 is also to allow the consumer to speak freely without worrying that the present invention's voice-command function will be activated at the wrong time. The voice command function is another element of the present invention that deals with the ease of use and portability. As we see in FIG. 2, the left and right sides of the present invention contain a left sound-receiving piece (60) and a right sound-receiving piece (70) respectively. The left sound receiving piece (60) and right sound-receiving piece (70) are used to recognize specific voice commands that are located with an emphasis on typical range for the location of the housing (20). The preferred embodiment places the left sound-receiving piece (60) and right sound-receiving piece (70) on the left and right side of the present invention in order to effectively capture relevant voice commands.

The voice command function relates to conventional technology familiar with those skilled in the field. When a voice command or specific food or beverage item is spoken and the voice reaches one or both of the left sound-receiving piece (60) and right sound-receiving piece (70) as seen in FIG. 2, the present invention recognizes the word through the voice command technology. Through pre-programmed or downloadable algorithms, these commands are interpreted by the system of the present invention through the memory storage element located inside the present invention housing (20). In respect to the internal placement of the memory storage element and other electronic functions, these aspects of the present invention are conventional and familiar with those skilled in the field. An additional embodiment of the present invention envisions a receiver/transmitter device attached to the system so that commands can be sent via wireless communications technology to a distant database that essentially retrieves the coded signal based on the initial voice command and returns the requested data through the distant database transmitter and back to the receiver/transmitter device of the present invention.

Additionally, FIG. 2 depicts an embodiment of the present invention featuring a rechargeable battery that is located within the housing (20). In FIG. 2, we see a rechargeable battery lip (85) that slightly protrudes out from the housing in order to make room for that rechargeable battery. A charger input (80) located on one side of the housing (20) permits the consumer to recharge the rechargeable battery of the system of the present invention via a conventional battery charger by inserting the charging end of the battery charger into the charger input (80). The rechargeable battery is the power source of the preferred embodiment of the present invention, although other power sources also may suffice, such as a small lithium battery.

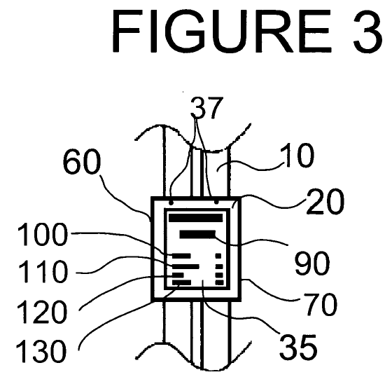

Because a preferred embodiment of the present invention is for its use as a calorie counter and targeted nutritional information resource, FIG. 3 highlights the fact that the display screen (35) is the most prominent item to be seen by the consumer. The display screen (35) uses a liquid-crystal display in the preferred embodiment but also may employ virtually any other type of conventional display screen conducive to portable technology. The display screen (35) is where the information stored within the system will be displayed for the consumer. However, the consumer does not have to rely on the display screen (35). Instead, the present invention is equipped with a conventional synthesized voice and speaker function. This aspect employs conventional technology that enables the system to “speak” to the consumer. In other words, information or complimentary words that are displayed on the display screen (35) also will be emitted through speakers (37) through the conventional synthesized voice and speaker function. The verbal information conveyed through the speakers (37) via the conventional synthesized voice and speaker function operates in sync with the visual information on the display screen (35). However, additional information may be emitted through the speakers (37) that are not exactly what is on the display screen (35), depending on the mode and circumstance. Essentially, the voice command function and the conventional synthesized voice and speaker function also permit the consumer to have variable verbal exchanges with the system. This works by having the consumer use the voice command function seeking some sort of nutritional information and then the system will respond through the conventional synthesized voice and speaker function via the speakers (37), in which case the consumer may then issue a reply via the voice command function. Additional embodiments of the present invention also avoid the use of more traditional speakers (37) and instead employ other technology such as BLUETOOTH™.

FIG. 3 depicts an example of how the present invention is used as an informational tool for the consumer. In this capacity, a consumer will verbally state the name of the food item that had been or is about to be consumed. The verbal command will be initially picked up by the left sound-receiving piece (60) and/or right sound-receiving piece (70) and ultimately converted into algorithm form through the internal functions of the present invention as the coded information reaches the memory storage element of the system. The nutritional information stored in the memory storage element will then be displayed in text form on the display screen (35). This nutritional information stored in the memory storage element also will be verbally conveyed to the consumer through the speakers (37) of the conventional synthesized voice and speaker function. Of course, the consumer has the option of silencing the conventional synthesized voice and speaker function.

In the example of FIG. 3, we see that a food item (90) is displayed on the display screen (35). It is understood that the verbal conveyance also was offered through the conventional synthesized voice and speaker function. Additional information gleaned from the memory storage element includes calories (100), fat (110), carbohydrates (120) and protein (130) that are contained in the food item. An additional voice command by the consumer can instruct the present invention to record and log this information into a database within the memory storage element. The present invention then may record the time and date of this recording into the log so that a proper accounting can be made by the consumer. Of course the consumer may pick and choose which information he or she wishes to log. The nutritional information displayed by the system or conveyed through the conventional synthesized voice and speaker function can be any type of nutritional information from standard items such as calories and carbohydrates to commercial point systems and percentage of recommended daily allowance.

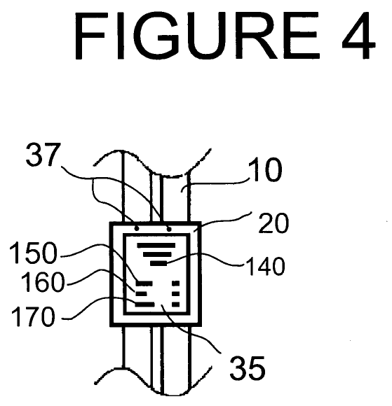

In FIG. 4, we see an embodiment of the present invention where a consumer may view the log containing information of the total calories consumed in a specific day (140). This total calorie mode, like the other modes of the present invention, is activated by the voice command function, although a manual system also is contemplated. This mode as seen in FIG. 4 may be used during any specified time period where the consumer is wishing to monitor his or her calorie or other nutritional intake. In FIG. 4, we see that a log is displayed on the display screen (35) and/or verbally conveyed through the conventional synthesized voice and speaker function, featuring total calories consumed in a specific day (140), total fat consumed (150), total carbohydrates consumed (160) and total protein consumed (170). A conventional time-keeping mechanism works with the memory storage element of the present invention in order to maintain logs and perform such simple mathematics as counting calories consumed over the course of a set period of time.

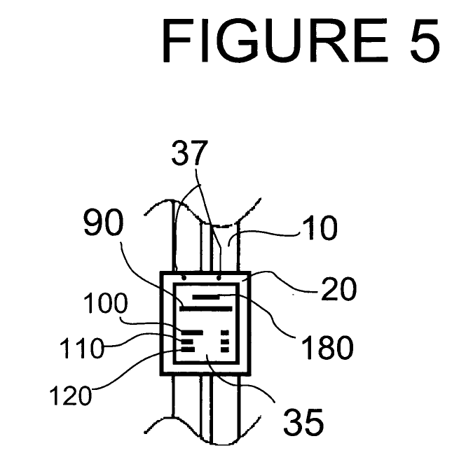

FIG. 5 depicts an example of the present invention while in restaurant mode. As mentioned above, the memory storage element of the present invention is pre-programmed with restaurant information detailing the nutritional value of dishes served at those restaurants. This information may be supplied to the programming source via restaurant participation or independent information that is accurately supplied. To operate in restaurant mode, the consumer may use the voice command function of the present invention to state the name of the restaurant and also state the name of the specified food or beverage item served at the restaurant. The voice command function operates the same in restaurant mode as it does in the informational tool mode described in FIG. 3. Once the consumer verbally commands the system to identify the restaurant and specific food or beverage item served at the restaurant, the display screen (35) and/or conventional synthesized voice and speaker function will identify the restaurant name (180), food item (90), and nutritional information of that food item (90) such as calories (100), fat (110), carbohydrates (120).

An example of an embodiment of the present invention relating to restaurant mode is as follows. A consumer may issue the verbal command for the BURGER KING™ fast food restaurant. The consumer may then issue a verbal command for the name of a WHOPPER™ sandwich. The system of the present invention will seek the nutritional information for that product from within the memory storage element. This nutritional information will then be visible on the display screen (35) and/or conveyed through the conventional synthesized voice and speaker function, as well as the restaurant name (180) of BURGER KING™, food item (90) of WHOPPER™, and nutritional information of that food item (90) such as calories (100), fat (110), carbohydrates (120). At this point, the consumer can use that nutritional information merely to receive the information relating to that sandwich. In other words, the consumer may simply view the nutritional information and ignore it, verbally command the system to a different mode or move on to a different food or drink item. However, the consumer also may log and record the nutritional information for that sandwich. One embodiment of the present invention envisions a “yes” or “no” command where once the nutritional information of a product is displayed, the system will ask the consumer if he or she would like to log that item. Another embodiment envisions that the consumer may simply command that the system “log WHOPPER™.” Variations on that aspect include proportions and product variations such as a sandwich with cheese or condiments.

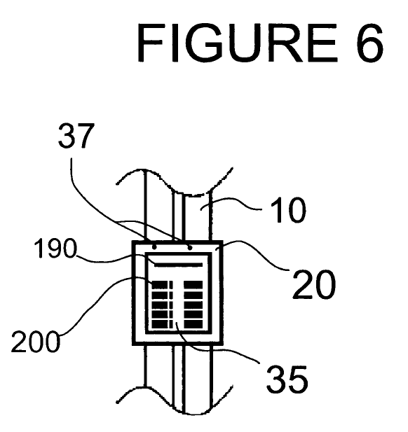

There are numerous other conceived applications for the present invention that extend beyond the preferred embodiment relating to nutrition and restaurant mode. For example, FIG. 6 depicts an alarm mode that functions to remind consumers who are part of specified diets or involved with other health conditions when they must eat, drink or take medication. Just like in the other modes, a consumer uses the voice command function to activate the alarm mode. When activated, alarm text (190) is viewed on the display screen (35) and/or conveyed through the speakers (37) of the conventional synthesized voice and speaker function. In addition, specific alarm information (200) also is displayed on the display screen (35) or through the conventional synthesized voice and speaker function. This mode also permits the user to achieve an alert for when certain nutritional requirements and/or guidelines have been met, are close to being met or have been surpassed. For example, if the consumer can only consume 2 grams of saturated fat per day, the present invention would alert the consumer when 2 grams of saturated fat have been consumed per day. In an additional example relating to this aspect, if a consumer has a dietary limit of 2,000 calories, the present invention could be set to issue an alert when the user is within a certain range relating to the target calories. An additional mode includes an aspect where daily menus of food are presented to the user based on the user's nutritional goals. An additional mode also includes alerting the user when certain positive developments regarding nutritional goals and exercise goals are achieved. This aspect is based on the fact that positive statements and positive attitudes are important elements in maintaining a fit lifestyle. It should be understood that conventional programming would allow the voice command function to set the parameters. An additional embodiment relating to the alert aspect can include audio, transmission via BLUETOOTH™ to a remote headset, vibration, text message or any other conventional electronic method.

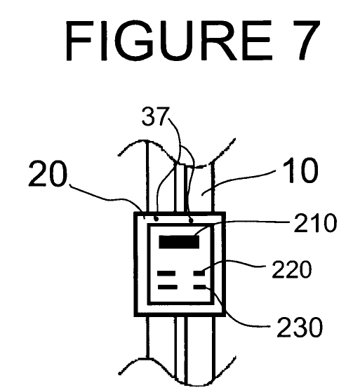

An additional embodiment of the present invention relates to the pedometer mode of FIG. 7. The pedometer mode is activated via the voice command function similar to the aforementioned functions of the present invention. In the mode of FIG. 7, the display screen (35) shows pedometer text (210) and also the number of steps (220) taken by the consumer along with the measured distance (230). The speakers (37) also can relate this information via the conventional synthesized voice and speaker function. Both the alarm and pedometer functions require additional internal aspects to be included into the system such as a noise or vibration function for the alarm mode of FIG. 6, and a movement-detecting element for the pedometer mode of FIG. 7.

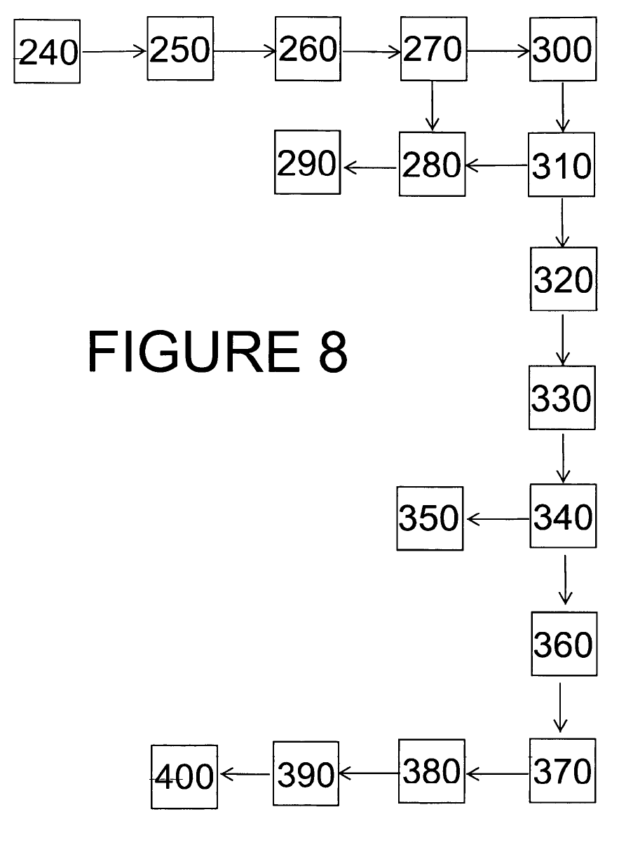

In FIG. 8, we see a flow chart that runs us through a typical use of the present invention as envisioned in the preferred embodiment. The first step relating to the present invention involves the memory storage element. The system of the present invention relies on correct nutritional information relating to specific food/beverage items, brands and reported restaurant dishes. Based on this factor, the relevant information must be programmed into the memory storage element (240). In the preferred embodiment, the memory database is stored within the system and may be preprogrammed with information relating to nutritional items for numerous food and restaurant items. An additional embodiment of the present invention envisions an update function through a receiver/transmitter to a stationary database or a USB port located within the system of the present invention for direct downloads at the consumer's convenience.

Once at least the initial relevant information is programmed into the memory storage element (240), the consumer can receive the system (250). At this point, the consumer may activate the system (260) using the voice command function. In the preferred embodiment of the present invention, the system possesses the option for a standard, voice-activated password that is stored within the voice command mainframe in order to at least operate the system for the first time. Once the consumer activates the system (260), he or she may set a unique password (270). The standard voice-activated password would be used by the consumer to verbally activate and deactivate the system for use. However, in respect to the setting of a unique password (270), the preferred embodiment also enables uniquely crafted password creation by the consumer through the standard voice command pre-programmed operation. In the alternative finger print password functionality may also be used.

Once the user is satisfied with setting a unique password (270), he or she has the option to deactivate the system (280), set the system to silent mode (290) or activate a function (300). Each of these options are operated either using the voice command function or the manual button press of the present invention. If the consumer opts to deactivate the system (280), the consumer is essentially turning it off and nothing is displayed on the display screen (35) or verbally conveyed through the speakers (37) of the conventional synthesized voice and speaker function. In the alternative if a cell phone headset is being used at the time the audio information would be transmitted through said device. This also contributed to power conservation. Setting the system to silent mode (290) relates back to the information contained in FIG. 1. A consumer would command the system to silent mode (290) when there is no nutritional information to be obtained or logged and the consumer merely is going about his or her day with the present invention serving as an accessory.

Once the consumer decided to activate a function (300), he or she may use the voice command function that will lead to a waiting voice mode (310) on the display screen (35). The waiting voice mode (310) of the preferred embodiment is similar to a command prompt as the system awaits a voice command. At this point, the consumer decides which mode to activate (320). For example, the consumer may be ready to eat an apple and a soda and want to know the amount of calories involved. The consumer will then make a verbal command such as “calorie mode (330)”. The display screen (35) then changes for viewing similar to FIG. 4. At the same time, the speakers will convey the relevant information via the speakers (37) of the conventional synthesized voice and speaker function. The consumer then may command “apple (340)”. Just as is the case in FIG. 4, the nutritional information of the apple will appear on the display screen and/or be verbally conveyed through the conventional synthesized voice and speaker function or the same may be transmitted to a cell phone earpiece if such is being used. The same sequence will occur if the consumer wishes to learn the calorie count of the specified soda. Once the calorie information is listed after a command such as “apple (340)”, the consumer may then order the system to log that listing (350). By logging that listing (350), the consumer has used the system of the present invention to record and log the calories ingested for that food or drink item.

Next, that consumer may then be considering dining at a nearby restaurant. More specifically, the consumer may wonder about the nutritional information contained in a spaghetti meal at a certain chain restaurant. The consumer then simply makes a verbal command of “X restaurant, spaghetti (360)”. The display screen (35) and the speakers of the conventional synthesized voice and speaker function then conveys the information (370) pertaining to X restaurant and specifically, the spaghetti nutritional information that had been preprogrammed into the memory storage element. If the consumer eats the spaghetti, he or she may then “log data” (380) relating to the spaghetti, meaning that the calories, fat, protein, carbohydrates and any other recorded nutritional data will be stored in the same manner as when the consumer in this example ordered the system to log that listing (350). At this point, the consumer may verbally order a review of the total calorie intake (390) for that day based on the memory storage element of the log. The consumer then may go through any other option or simply order the system “off (400).”

A number of different embodiments of the features and arrangement of the system have been described. All of these arrangements may be placed and designed in a single device that includes a cpu, static and non-static memory, an energy storage device (a rechargeable battery) as well as the standard interfaces herein described all wrapped in a pleasing package and such is the preferred embodiment of this device. It is however contemplated that in the alternative, where more processing power is needed that the voice and any other information may be transmitted to a remote server for appropriate analysis and then the resulting response would be sent back to the device worn by the user. Of course in such a case a standard cell phone circuit or some other known method (wifi, wimax, etc.) for Internet connectivity would be required. A rendition of the device with such connectivity would allow for the device to be expanded in its usefulness to include a cell phone or Skype functionality as well as other functions normally found on today's internet connected cell phones. Such functionality would also allow the user to not to have to use a wire to back up their device/see their progress via a close in transmission technology such as, but not limited to, physical wire, usb, fire wire, blue tooth, etc., but would allow the real time transmission of calories used and burned to a remote website. Such a website could be hosted in a centralized fashion by the company providing the device or could be hosted by the user on their own machine.

The power requirements for this device are clearly meager as described in its preferred embodiment. However if any of the additional embodiments are implemented the power could become an issue. As the individual is wearing this device then additional energy for the functioning of the device could be obtained using a standard kinetic energy generator that garners electricity from the movement of the person.

It should be understood that the electronics and technological aspect of the voice command function and conventional synthesized voice and speaker function are not specific in nature and that the electronics and technological aspect of the voice command function and conventional synthesized voice and speaker function are conventional in nature. It is the features and arrangement of the system that are patentable. It also is to be understood that the present invention is not limited to the sole embodiment described above, but encompasses any and all embodiments within the scope of the following claims.

I claim:

1. A nutrition information system, comprising:
a display screen;
a voice command function;
a power source;
memory storage capability with various modes configured to alert a user when certain nutritional requirements and/or guidelines have been met, are close to being met or have been surpassed; and
said memory storage further configured to present a user with daily menus of consumable items based on the user's nutritional goals.

2. The nutrition information system of claim 1, wherein said display screen is secured to a housing, both of which are constructed via conventional means.

3. The nutrition information system of claim 2, wherein said display screen provides visual information that is in sync with speakers that emit verbal information through a conventional synthesized voice and speaker function.

4. The nutrition information system of claim 1, wherein said voice command function accepts verbal commands from a user.

5. The nutrition information system of claim 4, wherein said voice command function is secured via a password.

6. The nutrition information system of claim 1, wherein said system is powered by a conventional power source.

7. The nutrition information system of claim 1, wherein said memory storage capability works in conjunction with the overall system.

8. The nutrition information system of claim 7, wherein said memory storage capability is programmed with nutritional information of edible products on the market.

9. The nutrition information system of claim 7, wherein said memory storage capability is programmed with nutritional information relating to edible products available at restaurants and dining establishments.

10. The nutrition information system of claim 9, wherein programmed information of said memory storage capability may be updated via conventional data-transferring means.

11. The nutrition information system of claim 1, wherein user issues verbal commands via said voice command function relating to specific edible items on the market or at restaurants and dining establishments.

12. The nutrition information system of claim 11, wherein said voice command function relating to specific edible items on the market or at restaurants and dining establishments is transferred to said memory storage capability via conventional means.

13. The nutrition information system of claim 12, wherein said memory storage capability locates nutritional data relating to specific edible items on the market or at restaurants and dining establishments and transfers data via conventional means to display screen and said speakers via said conventional synthesized voice and speaker function.

14. The nutrition information system of claim 13, wherein said display screen provides visual images and text relating to the data while said speakers provide verbal information.

15. The nutrition information system of claim 7, wherein said memory storage capability logs, retains and catalogues data when commanded by user via said voice command function.

16. The nutrition information system of claim 15, wherein logs retained in said memory storage capability may be visually displayed on said display screen via conventional means when verbally commanded via voice command function.

17. The nutrition information system of claim 1, wherein said display screen provides visual displays of time management, exercise movements, alerts and health conditions that are monitored and gleaned via conventional means contained within the system.

18. The nutrition information system of claim 1, wherein said display screen, voice command function, power source, and memory storage capability are contained in a portable housing.

19. A nutrition information system, comprising:
a display screen;
a voice command function;
a power source; and
memory storage capability with various modes configured to alert a user when certain nutritional requirements and/or guidelines have been met, are close to being met or have been surpassed;
securing said display screen housing, both of which are constructed via conventional means;
wherein said display screen provides visual information;
wherein speakers provide verbal information via conventional synthesized voice and speaker function;
wherein said voice command function accepts verbal commands from a user;
wherein said voice command function is operated via conventional means;
wherein said voice command function is secured via a user password that is set up by said user pursuant to a verbal command as verbally programmed by said user;
wherein said system is powered by a conventional power source;
wherein said memory storage capability works in conjunction with the overall system;
wherein said memory storage capability is programmed with nutritional information of edible products on the market;
wherein said memory storage capability is programmed with nutritional information relating to edible products available at restaurants and dining establishments;
wherein programmed information of said memory storage capability may be updated via conventional data-transferring means;
wherein user issues verbal commands via said voice command function relating to specific edible items on the market or at restaurants and dining establishments;
wherein said voice command function relating to specific edible items on the market or at restaurants and dining establishments is transferred to said memory storage capability via conventional means;
wherein said memory storage capability locates nutritional data relating to specific edible items on the market or at restaurants and dining establishments and transfers data via conventional means to display screen;
wherein said display screen provides visual images and text relating to the data;
wherein said speakers provide verbal information relating to the data;
wherein said memory storage capability logs, retains and catalogues data when commanded by user via said voice command function;
wherein logs retained in said memory storage capability may be visually displayed on said display screen via conventional means or verbally conveyed through said speakers when verbally commanded via voice command function;
wherein said display screen provides visual displays of time management, exercise movements, alerts, and health conditions that are monitored and gleaned via conventional means contained within the system;
and
wherein said display screen, voice command function, power source, and memory storage capability are contained in a portable housing.

20. A nutrition information system, comprising the steps of:
choosing food items from a database;
allowing the database to calculate nutritional information for the food items;
logging food items that are consumed in the database;
voice commanding said choosing food items from a database and said logging food items that are consumed in the database;
alerting the user when certain nutritional requirements and/or guidelines have been met, are close to being met or have been surpassed; and
presenting the user with daily menus of consumable items based on the user's nutritional goals.
alerting the user when certain positive developments regarding nutritional goals and exercise goals are achieved.
